(19) United States
(12) Patent Application Publication
(10) Pub. No.: US 2019/0324319 A1
(43) Pub. Date: Oct. 24, 2019

(54) LIQUID CRYSTAL DISPLAY PANEL AND LIQUID CRYSTAL DISPLAY DEVICE INCLUDING THE SAME

(71) Applicant: Samsung Display Co., Ltd., Yongin-si (KR)

(72) Inventors: Keunwoo PARK, Incheon (KR); Jangsoo KIM, Asan-si (KR); Taewoo LIM, Yongin-si (KR); Cheonjae MAENG, Suwon-si (KR); Seongyeon LEE, Asan-si (KR); Hongbeom LEE, Hwaseong-si (KR)

(21) Appl. No.: 16/377,068

(22) Filed: Apr. 5, 2019

(30) Foreign Application Priority Data
Apr. 23, 2018 (KR) 10-2018-0046651

(51) Int. Cl. G02F 1/1335; G02F 1/1362; G02F 1/1339; G02F 1/13357

(52) U.S. Cl. CPC G02F 1/133528; G02F 1/136277; G02F 2001/136222; G02F 1/1336; G02F 2001/133548; G02F 1/1339

(57) ABSTRACT

A liquid crystal display panel and a liquid crystal display device may include a first substrate and a second substrate, which face each other, and a liquid crystal layer disposed therebetween. The first substrate may include a first base substrate, a color conversion layer disposed on the first base substrate and including a quantum dot, and a first polarizing layer disposed on the color conversion layer. The liquid crystal display device may exhibit a high color reproduction property and improved reliability.

### CROSS-REFERENCE TO RELATED APPLICATION

This application claims priority to and the benefit of Korean Patent Application No. 10-2018-0046651, filed on Apr. 23, 2018, the entire content of which is hereby incorporated by reference.

### BACKGROUND

### Field

The present disclosure herein relates to a liquid crystal panel and a liquid crystal display device including the same, and more particularly, to a liquid crystal panel, including a color conversion layer, and a liquid crystal display device including the same.

### Description of the Related Art

Various shapes of display devices have been utilized to provide image information. Among the display devices, a liquid crystal display device is being utilized in a large-sized display device, a portable display device, and various other display devices due to low power consumption. In case of the liquid crystal display device, various kinds of optical members are added to a backlight unit in order to increase a color reproduction property and improve an optical efficiency.

In recent years, although a color conversion layer is utilized for the backlight unit to realize excellent optical characteristics, the color conversion layer may be exposed to the outside, and may be damaged or lowered in reliability during a process of assembling the backlight unit and the liquid crystal display panel.

### SUMMARY

An aspect of the present disclosure is directed toward a liquid crystal display panel with improved reliability of a color conversion layer.

Another aspect of the present disclosure is directed toward a liquid crystal display device that maintains favorable optical characteristics and having improved reliability of a color conversion layer even when a low refractive index layer is omitted (e.g., not included) from a light source member.

According to an embodiment of the inventive concept, a liquid crystal display panel includes a first substrate, a second substrate facing the first substrate, and a liquid crystal layer between the first substrate and the second substrate. The first substrate may include: a first base substrate; a color conversion layer on the first base substrate and including a quantum dot; and a first polarizing layer on the color conversion layer.

In an embodiment, the second substrate may include: a second base substrate; a second polarizing layer on liquid crystal layer; a circuit layer on a bottom surface of the second base substrate, the bottom surface facing the liquid crystal layer; and a color filter layer between the liquid crystal layer and the circuit layer.

In an embodiment, the color conversion layer may be directly on the first base substrate.

In an embodiment, the liquid crystal display panel may further include a barrier layer on the color conversion layer.

In an embodiment, the first polarizing layer may be a wire grid polarizer.

In an embodiment, the liquid crystal display panel may further include a capping layer on the first polarizing layer.

In an embodiment, the second polarizing layer may be a low reflection polarizer.

In an embodiment, the circuit layer may include a thin film transistor, the thin film transistor including a gate electrode, a first electrode, a second electrode, and a semiconductor pattern; and the liquid crystal display panel may further include a column spacer overlapping the thin film transistor and protruding from the second substrate toward the liquid crystal layer.

In an embodiment, the column spacer may include a polymer resin and a pigment or a dye dispersed in the polymer resin.

In an embodiment of the inventive concept, a liquid crystal display device includes: a light source member; and a liquid crystal display panel on the light source member. The liquid crystal display panel may include a first substrate; a second substrate facing the first substrate; and a liquid crystal layer between the first substrate and the second substrate. The first substrate may include: a first base substrate; a color conversion layer on the first base substrate and including a quantum dot; and a first polarizing layer on the color conversion layer.

In an embodiment, the light source member may include: a light source including a circuit board and a light emitting element on the circuit board; and a guide panel configured to guide light from the light source to the liquid crystal display panel.

In an embodiment, the guide panel may include a plurality of emission patterns on a bottom surface thereof.

In an embodiment, each of the emission patterns may have a lens shape protruding from the bottom surface of the guide panel.

In an embodiment, the light emitting element may be configured to emit blue light, and the quantum dot may include a first quantum dot to be excited by the blue light to emit green light and a second quantum dot to be excited by the blue light to emit red light.

In an embodiment, the second substrate may include: a second base substrate: a second polarizing layer on the liquid crystal layer; a circuit layer on a bottom surface of the second base substrate, the bottom surface facing the liquid crystal layer; and a color filter layer between the liquid crystal layer and the circuit layer.

In an embodiment, the light source may be on at least one side surface of the guide panel.

In an embodiment, the liquid crystal display device may include an air gap between the liquid crystal panel and the guide panel.

In an embodiment of the inventive concept, a liquid crystal display device includes: a light source member; and a liquid crystal display panel on the light source member. The liquid crystal display panel may include a first substrate; a second substrate facing the first substrate; and a liquid crystal layer between the first substrate and the second substrate. The light source member may include: a light source configured to emit blue light; and a guide panel having one side surface facing an emission surface of the light source. The first substrate may include: a first base substrate; a color conversion layer directly on the first base substrate and including a first quantum dot to be excited by the blue light to emit green light and a second quantum dot to be excited by the blue light to emit red light; and a first polarizing layer on the color conversion layer. The second substrate may include: a color filter layer on the liquid crystal layer; a circuit layer on the color filter layer; a second base substrate on the circuit layer; and a second polarizing layer on the second base substrate.

In an embodiment, the liquid crystal display panel may be on the light source member and is spaced apart therefrom.

In an embodiment, the guide panel may include a plurality of emission patterns protruding from a bottom surface thereof.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is an exploded perspective view illustrating a liquid crystal display device according to an embodiment;

FIG. 2 is a cross-sectional view illustrating a liquid crystal display panel according to an embodiment, taken along the line I-I′ of the liquid crystal display device according to an embodiment in FIG. 1;

FIG. 3 is a cross-sectional view illustrating a portion of a color conversion layer according to an embodiment;

FIG. 4A is a plan view illustrating a pixel provided in a liquid crystal display device according to an embodiment;

FIG. 4B is a plan view illustrating a pixel provided in a liquid crystal display device according to an embodiment;

FIG. 5 is a cross-sectional view taken along the line III-III′ of FIG. 4A;

FIG. 6 is a cross-sectional view illustrating the liquid crystal display device according to an embodiment, which is taken along the line II-II′ of FIG. 1;

FIG. 7 is a schematic view illustrating a light source member according to an embodiment; and

FIG. 8 is a schematic view illustrating a light path in an area AA of FIG. 6.

### DETAILED DESCRIPTION

Because the present disclosure may have various (e.g., diverse) modified embodiments, specific embodiments are illustrated in the drawings and are described in the detailed description of the inventive concept. However, this does not limit the present disclosure to be within specific embodiments and it should be understood that the present disclosure covers all the modifications, equivalents, and replacements within the idea and technical scope of the present disclosure.

Like reference numerals refer to like elements throughout. In the drawings, the dimensions and size of each structure may be exaggerated, omitted, or schematically illustrated for convenience in description and clarity. It will be understood that although the terms such as “first” and “second” are used herein to describe various elements, these elements should not be limited by these terms. The terms are only used to distinguish one component from other components. For example, an element referred to as a first element in one embodiment can be referred to as a second element in another embodiment without departing from the scope of the appended claims. The terms of a singular form may include plural forms unless the context clearly indicates otherwise.

The term “include” or “comprise” specifies the presence of a property, a region, a fixed number, a step, a process, an element and/or a component, but does not exclude other properties, regions, fixed numbers, steps, processes, elements and/or components.

In the specification, it will be understood that when a layer (or film), a region, or a plate is referred to as being “on” another layer, region, or plate, it can be directly on the other layer, region, or plate, or intervening layers, regions, or plates may also be present. Similarly, it will be understood that when a layer, a film, a region, or a plate is referred to as being “under” another layer, region, or plate, it can be directly under the other layer (or film), region, or plate, or intervening layers, regions, or plates may also be present. Also, in the specification, it will be understood that when a layer (or film) is referred to as being “on” another layer or substrate, it can be disposed on a lower portion as well as an upper portion thereof, it can be directly on the other layer or substrate, or intervening layers may also be present. In the figures, the dimensions of layers and regions may be exaggerated for clarity of illustration.

Also, when an element is referred to as being “directly on” or “directly connected to” another element or layer, there are no intervening elements or layers present. For example, when the word “directly” is used, it refers to that no intervening constituent element, such as an adhesion layer, is present between two layers or two members.

Hereinafter, a display device and a method for manufacturing the same according to an embodiment of the inventive concept will be described with reference to the accompanying drawings.

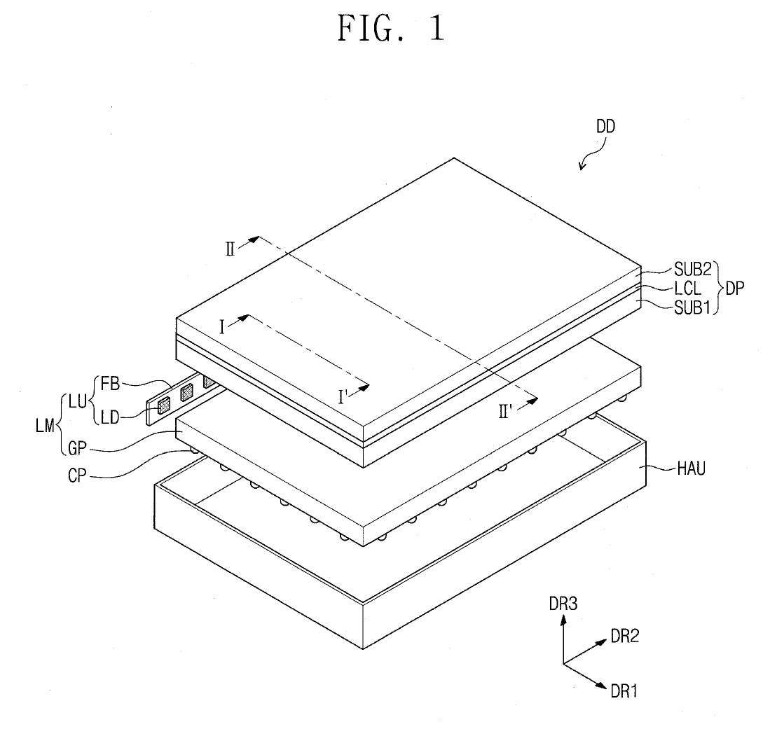

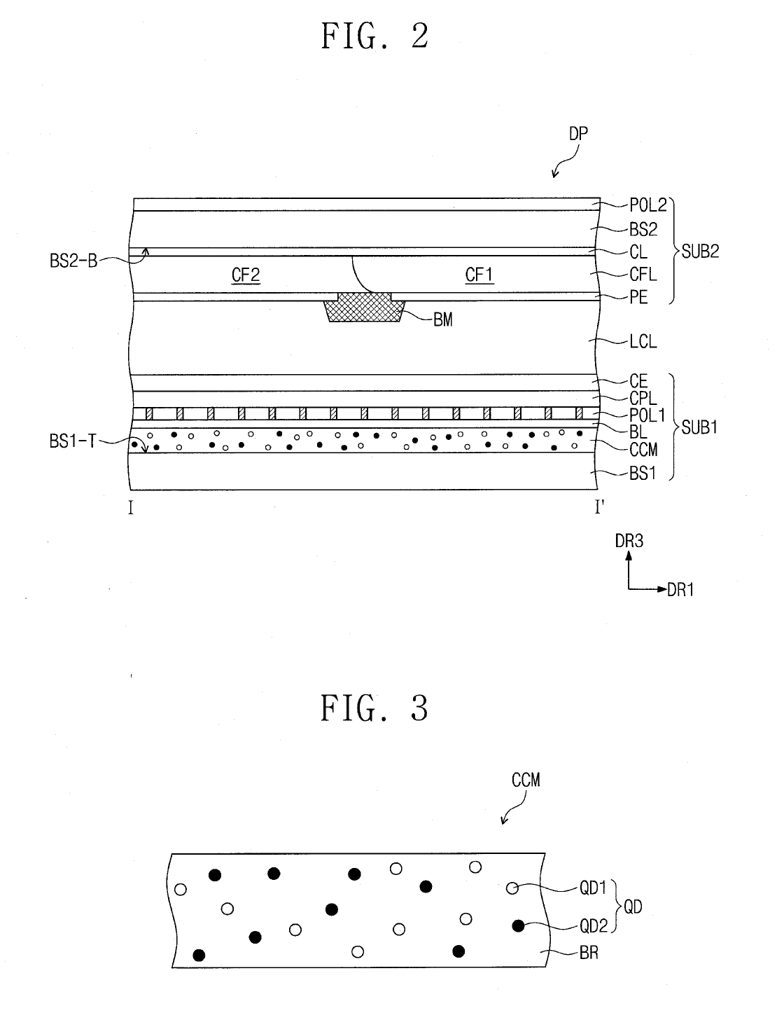

FIG. 1 is an exploded perspective view of a liquid crystal display device according to an embodiment of the inventive concept. FIG. 2 is a cross-sectional view illustrating a portion of a liquid crystal panel provided in the liquid crystal display device according to an embodiment of the inventive concept.

Referring to FIG. 1, a liquid crystal display device DD according to an embodiment may include a liquid crystal display panel DP and a light source member LM disposed on the liquid crystal display panel DP. The liquid crystal display panel DP may be disposed on the light source member LM.

Although a first directional axis DR1 to a third directional axis DR3 are illustrated in FIG. 1, the directional axis described in this specification may be relative concepts. For example, a direction of the third directional axis DR3 in FIG. 1 may be defined as a direction in which an image is provided for convenience of description. Also, the first directional axis DR1 and the second directional axis DR2 may cross (e.g., be perpendicular to) each other, and the third directional axis DR3 may be at a normal direction with respect to a plane defined by the first directional axis DR1 and the second directional axis DR2.

Referring to FIG. 1, the liquid crystal display panel DP may include a first substrate SUB1, a second substrate SUB2, which face each other, and a liquid crystal layer LCL disposed between the first substrate SUB1 and the second substrate SUB2.

The light source member LM may include a light source LU and a guide panel GP guiding light provided from the light source LU toward the liquid crystal panel DP. The light source LU may include a circuit board FB and a light emitting element LD disposed on the circuit board FB, and the guide panel GP may include an emission pattern CP for transmitting the light provided from the light source LU to the liquid crystal display panel DP.

Also, the liquid crystal display device DD according to an embodiment may further include a housing HAU for accommodating the light source member LM and the liquid crystal display panel DP. The housing HAU may cover the light source member LM and the liquid crystal display panel DP so as to expose a top surface of the second substrate SUB2, which is a display surface of the liquid crystal display panel DP. Also, the housing HAU may cover a portion of the top surface of the second substrate SUB2 in addition to a side surface and a bottom surface of the liquid crystal display panel DP.

FIG. 2 is a cross-sectional view illustrating a portion of the liquid crystal display panel DP at a portion corresponding to the line I-I′ of the liquid crystal display device DD according to an embodiment in FIG. 1. FIG. 2 illustrates a cross-section of the liquid crystal display panel DP on a plane in parallel to the plane defined by the first directional axis DR1 and the third directional axis DR3.

The first substrate SUB1 of the liquid crystal display panel DP according to an embodiment in FIG. 2 may include a first base substrate BS1, a color conversion layer CCM disposed on the first base substrate BS1, and a first polarizing layer POL1 disposed on the color conversion layer CCM.

The first base substrate BS1 may be a glass substrate. However, the embodiment of the inventive concept is not limited thereto. For example, the first base substrate BS1 may be a quartz substrate or a transparent resin substrate. For example, the first base substrate BS1 may contain a polyimide-based resin, an acryl-based resin, a polyacrylate-based resin, a polycarbonate-based resin, and a polyethyleneterephthalate-based resin. The first base substrate BS1 may be utilized as a lower substrate of the liquid crystal display panel DP according to an embodiment. The first base substrate BS1 may serve as a base on which a color conversion layer CCM and a first polarizing layer POL1, which will be described later, are disposed.

Referring to FIG. 2, the color conversion layer CCM may be disposed directly on the first base substrate BS1. That is, the color conversion layer CCM may be disposed directly on the first base substrate BS1 to contact a top surface BS1-T of the first base substrate BS1.

FIG. 3 is a cross-sectional view illustrating a portion of the color conversion layer CCM according to an embodiment. Referring to FIG. 3, the color conversion layer CCM according to an embodiment may include a base resin BR and a quantum dot QD. The quantum dot QD may be dispersed in the base resin BR.

The base resin BR, as a medium in which the quantum dot QD is dispersed, may be made of various suitable resin compositions, which may be generally referred to as a binder. However, the embodiment of the inventive concept is not limited thereto. For example, in this specification, a medium, in which the quantum dot QD may be dispersed, may be referred to as the base resin BR regardless of a name, an additional function, or a constituent thereof. The base resin BR may be a polymer resin. For example, the base resin BR may be an acryl-based resin, a urethane-based resin, a silicone-based resin, and/or an epoxy-based resin. The base resin BR may be a transparent resin.

The quantum dot QD may be particles for converting a wavelength of light provided from the light source member LM (refer to FIG. 1). The quantum dot QD, which is a material having a crystal structure and a size of several nanometers, includes several hundred to several thousand atoms and generates a quantum confinement effect of increasing an energy band gap (e.g., effect of having its energy band gap increased) due to a small size thereof. When light having a wavelength with energy greater than a band gap is incident into the quantum dot QD, the quantum dot QD may become excited (e.g., be in an excited state) by absorbing the light and then return (e.g., be dropped) to a ground state while emitting light having a specific wavelength. The specific wavelength of the emitted light has a value corresponding to the band gap. When the quantum dot QD is adjusted in size and composition, a light emitting characteristic due to the quantum confinement effect may be adjusted.

The quantum dot QD may be selected from Group II-VI compound, Group III-V compound, Group IV-VI compound, Group IV element, Group IV compound, and a combination thereof.

The Group II-VI compound may be selected from a binary compound selected from CdSe, CdTe, ZnS, ZnSe, ZnTe, ZnO, HgS, HgSe, HgTe, MgSe, MgS, and a combination thereof; a ternary compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a combination thereof; and a quaternary compound selected from HgZnTeS, CdZnSeS, CdZnSeTe, CdZnSTe, CdHgSeS, CdHgSeTe, CdHgSTe, HgZnSeS, HgZnSeTe, HgZnSTe, and a combination thereof.

The III-V compound may be selected from: a binary compound selected from GaN, GaP, GaAs, GaSb, AlN, AlP, AlAs, AlSb, InN, InP, InAs, InSb, and a combination thereof; a ternary compound selected from GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and a combination thereof; and a quaternary compound selected from GaAlNAs, GaAlNSb, GaAlPAs, GaAlPSb, GaInNP, GaInNAs, GaInNSb, GaInPAs, GalnPSb, InAlNP, InAlNAs, InAlNSb, InAlPAs, InAlPSb, and a combination thereof. The IV-VI compound may be selected from: a binary compound selected from SnS, SnSe, SnTe, PbS, PbSe, PbTe, and a combination thereof; a ternary compound selected from SnSeS, SnSeTe, SnSTe, PbSeS, PbSeTe, PbSTe, SnPbS, SnPbSe, SnPbTe, and a combination thereof; and a quaternary compound selected from SnPbSSe, SnPbSeTe, SnPbSTe, and a combination thereof. The Group IV compound may be selected from Si, Ge, and a combination thereof. The Group IV compound may be a binary compound selected from SiC, SiGe, and a combination thereof.

Here, the binary compound, the ternary compound, and the quaternary compound may exist in (e.g., in the form of) a particle with a uniform concentration or exist in the same particle while being divided in a state in which a concentration distribution is partially different (e.g., non-uniform).

The quantum dot QD may have a core shell structure including a core and a shell surrounding the core. In one embodiment, the quantum dot QD may have a core/shell structure in which one quantum dot surrounds another quantum dot. An interface between the core and the shell may have a concentration gradient in which a concentration of an element existing in the shell gradually decreases in a direction toward a center thereof.

The quantum dot QD may be a particle having a size in a nanometer scale. The quantum dot QD may have a light emitting wavelength spectrum with a full width at half maximum (FWHM) equal to or less than about 45 nm, for example, equal to or less than about 40 nm, or equal to or less than about 30 nm. When the FWHM is within these ranges, a color purity or a color reproduction property may be improved. Also, because light emitted through the above-described quantum dot QD is emitted in all directions, a wide viewing angle may be improved.

Also, although the quantum dot QD may have a shape that is generally utilized in the field, the embodiment of the inventive concept is not limited thereto. In more detail, the quantum dot may have a suitable shape such as a globular shape, a pyramid shape, a multi-arm shape, or the shape of a nano-particle, a nano-tube, a nano-wire, a nano-fiber, or a nano-plate.

In an embodiment, the color conversion layer CCM may include a plurality of quantum dots QD converting incident light into colors in wavelength regions different from one another. Referring to FIG. 3, in an embodiment, the color conversion layer CCM may include, e.g., a first quantum dot QD1 converting incident light having a specific wavelength into light having a first wavelength and emit the converted light and a second quantum dot QD2 converting incident light having a specific wavelength into light having a second wavelength and emit the converted light.

Alternatively, in another embodiment of FIG. 3, the color conversion layer CCM may further include the base resin BR and scattering particles dispersed in the base resin BR. The scattering particles may be TiO₂ or silica-based nanoparticles. The scattering particles may allow light emitted from the quantum dots QD1 and QD2 to be scattered and emitted out of the color conversion layer CCM.

For example, when the color conversion layer CCM includes a plurality of quantum dots QD1 and QD2, and light provided from the light source member LM (refer to FIG. 1) is light in a wavelength region of blue light, the first quantum dot QD1 may convert the light in a wavelength region of blue light into light in a wavelength region of green light, and the second quantum dot QD2 may convert the light in a wavelength region of blue light into light in a wavelength region of red light. In more detail, when the light provided from the light source member LM (refer to FIG. 1) is blue light having a maximum emission peak of about 420 nm to about 470 nm, the first quantum dot QD1 may emit green light having a maximum emission peak of about 520 nm to about 570 nm, and the second quantum dot QD2 may emit red light having a maximum emission peak of about 620 nm to about 670 nm. However, the embodiment of the inventive concept is not limited to the above-described wavelength range of the blue light, the green light, and the red light. All of the wavelength ranges that may be recognized as blue light, green light, and red light in the technical field may be included.

Also, the color of light may vary according to a particle size of quantum dots QD1 and QD2, and the first quantum dot QD1 and the second quantum dot QD2 may be different in particle size. For example, the first quantum dot QD1 may have a particle size less than that of the second quantum dot QD2. Here, the first quantum dot QD1 may emit light having a wavelength shorter than that of the second quantum dot QD2.

Referring to FIG. 2 again, the color conversion layer CCM may be disposed directly on the first base substrate BS1, and, for example, the color conversion layer CCM may be formed by being applied on the first base substrate BS1. The color conversion layer CCM may be applied on the first base substrate BS1 through various suitable methods, such as slit coating, spin coating, roll coating, spray coating, and ink-jet printing.

In an embodiment of FIG. 2, the first substrate SUB1 of the liquid crystal display panel DP may include a first polarizing layer POL1. The first polarizing layer POL1 may be an in-cell type (e.g., kind) polarizing layer disposed between the first base substrate BS1 and the liquid crystal layer LCL.

The first polarizing layer POL1 may be a coating-type (e.g., a coatable) polarizing layer or a polarizing layer formed through deposition. The first polarizing layer POL1 may be formed by applying a material containing dichroic dye and a liquid crystal compound. In one embodiment, the first polarizing layer POL1 may be a wire grid polarizer.

The first polarizing layer POL1 may include a plurality of protruding portions that are spaced at a set or predetermined distance from each other to form the wire grid and have the same shape as each other. The wire grid polarizer may have a pitch of about 50 nm to 150 nm. Here, the pitch of the wire grid polarizer may refer to a spaced distance between the protruding portions, which are adjacent to each other. When the first polarizing layer POL1 is the polarizer, the first polarizing layer POL1 may contain at least one metal such as aluminum (Al), titanium (Ti), chrome (Cr), silver (Ag), copper (Cu), nickel (Ni), iron (Fe), and cobalt (Co).

The first polarizing layer POL1 may be disposed on the color conversion layer CCM. The first polarizing layer POL1 may polarize light, which is provided by passing through the color conversion layer CCM, in one direction. The first polarizing layer POL1 may be disposed on the color conversion layer CCM to reflect a portion of the light provided from the color conversion layer CCM and allow the reflected light to be re-converted in the color conversion layer CCM, thereby improving the light efficiency of the liquid crystal display panel.

The first substrate SUB1 may further include a barrier layer BL disposed on the color conversion layer CCM. The barrier layer BL may serve to block moisture and/or oxygen (hereinafter, referred to as “moisture/oxygen”) from being introduced. The barrier layer BL may be disposed on the color conversion layer CCM to block the moisture/oxygen from being introduced into the color conversion layer CCM. In one embodiment, the barrier layer BL may cover the color conversion layer CCM.

The barrier layer BL may include at least one inorganic layer. That is, the barrier layer BL may contain an inorganic material. For example, the barrier layer BL may include silicon nitride, aluminum nitride, zirconium nitride, titanium nitride, hafnium nitride, tantalum nitride, silicon oxide, aluminum oxide, titanium oxide, tin oxide, cerium oxide, silicon oxynitride, and/or a metal thin-film securing a light transmittance. In one embodiment, the barrier layer BL may further include an organic layer. The barrier layer BL may include (e.g., be constituted by) a single layer or a plurality of layers.

The first substrate SUB1 may include a common electrode CE. The common electrode CE may be formed by depositing indium tin oxide (ITO) and/or indium zinc oxide (IZO). The common electrode CE may face a pixel electrode PE provided in the second substrate SUB2, which will be described later.

Also, the first substrate SUB1 may further include a capping layer CPL disposed on the first polarizing layer POL1. The capping layer CPL may insulate between the first polarizing layer POL1 and the common electrode CE, which are made of a metal material. The capping layer CPL may be made of an inorganic insulating material such as silicon oxide (SiOx) and/or silicon nitride (SiNx).

The first substrate SUB1 may include the first base substrate BS1, the color conversion layer CCM, the barrier layer BL, the first polarizing layer POL1, the capping layer CPL, and the common electrode CE, which are sequentially laminated in the third directional axis DR3. In one embodiment, an alignment layer may further be disposed between the common electrode CE and the liquid crystal layer LCL.

The second substrate SUB2 may face the first substrate SUB1 with the liquid crystal layer LCL therebetween and include a second base substrate BS2, a second polarizing layer POL2, a circuit layer CL, and a color filter layer CFL.

The second base substrate BS2 may be a glass substrate. However, the embodiment of the inventive concept is not limited thereto. For example, the second base substrate BS2 may be a quartz substrate and/or a transparent resin substrate. For example, the second base substrate BS1 may contain a polyimide-based resin, an acryl-based resin, a polyacrylate-based resin, a polycarbonate-based resin, and/or a polyethyleneterephthalate-based resin. The second base substrate BS2 may be utilized as an upper substrate of the liquid crystal display panel DP according to an embodiment. The second base substrate BS2 may serve as a base on which the circuit layer CL and the color filter layer CFL, which will be described later, are disposed.

Referring to the illustration of FIG. 2, the second substrate SUB2 may include the second base substrate BS2, the circuit layer CL disposed on a bottom surface BS2-B of the second base substrate BS2, and the color filter layer CFL disposed between the circuit layer CL and the liquid crystal layer LCL. The liquid crystal display panel DP according to an embodiment may include the second substrate SUB2 including both the circuit layer CL and the color filter layer CFL.

The pixel electrode PE may face the common electrode CE with the liquid crystal layer LCL therebetween. The pixel electrode PE may be disposed between the liquid crystal layer LCL and the color filter layer CFL. The pixel electrode PE may be made of a transparent conductive material. In one embodiment, the pixel electrode PE is made of a transparent conductive oxide. The transparent conductive oxide may include indium tin oxide (ITO), indium zinc oxide (IZO), and/or indium tin zinc oxide (ITZO).

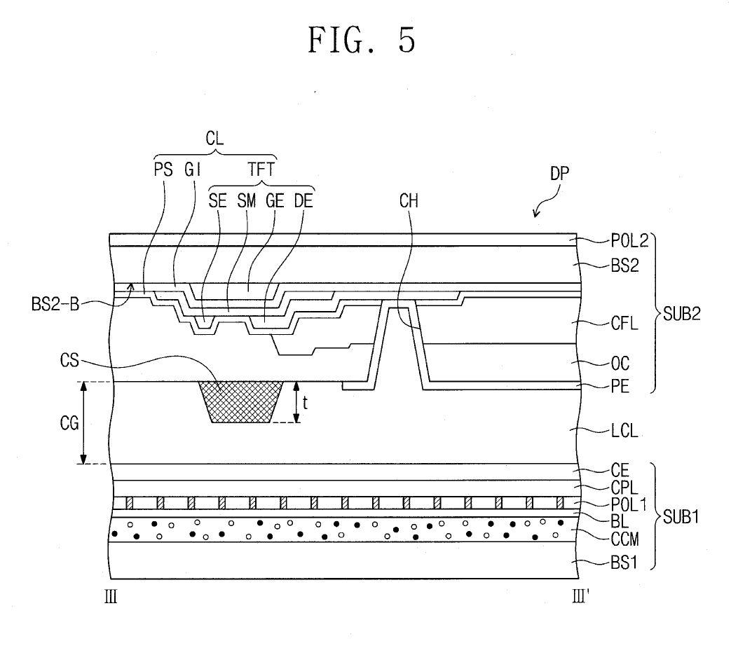

Also, a low reflective pattern may be further provided between the circuit layer CL and the second base substrate BS2. The low reflective pattern, which is. made of metal having low reflectivity, may block a portion of light transmitting through the second base substrate BS2 and provided to the circuit layer CL. For example, the low reflective pattern may overlap some components of a thin film transistor TFT (refer to FIG. 5). As the low reflective pattern is provided, external light may be partially blocked from being reflected by the thin film transistor TFT (refer to FIG. 5).

Alternatively, in one embodiment, the second substrate SUB2 may further include a column spacer CS (refer to FIG. 5) having a light shielding function between the liquid crystal layer LCL and the circuit layer CL in order to reduce or prevent light, which is provided by transmitting through the color conversion layer CCM, from being directly provided to the circuit layer CL. The column spacer CS (refer to FIG. 5) may be a black column spacer. Also, the column spacer CS (refer to FIG. 5), which contains a dye and/or a pigment, may absorb the light transmitted through the color conversion layer CCM.

The color filter layer CFL may include a plurality of filter parts CF1 and CF2 allowing light in different wavelength regions to transmit therethrough. A light shielding part BM may be further disposed between the filter parts, which are adjacent to each other, among the plurality of filter parts CF1 and CF2. The light shielding part BM may overlap a boundary between the filter parts CF1 and CF2, which are adjacent to each other.

The light shielding part BM may be a black matrix. The light shielding part BM may be made of an organic light shielding material and/or an inorganic light shielding material, which contains a black pigment and/or dye. The light shielding part BM may reduce or prevent a light leakage phenomenon, and distinguish the adjacent filter parts CF1 and CF2 from each other.

The light shielding part BM and the column spacer CS (refer to FIG. 5) may be formed through the same process. The light shielding part BM and the column spacer CS (refer to FIG. 5) may be made of the same material. For example, each of the light shielding part BM and the column spacer CS (refer to FIG. 5) may be made of an organic light shielding material and/or an inorganic light shielding material, which contains a black pigment and/or dye.

Although the two adjacent filter parts CF1 and CF2 are illustrated in FIG. 2, the embodiment of the inventive concept is not limited thereto. For example, the color filter layer CFL may include three or more filter parts to allow light in different wavelength regions to transmit therethrough. For example, the color filter layer CFL may include a red filter part (e.g., a red light filter), a green filter part (e.g., a green light filter), and a blue filter part (e.g., a blue light filter) or may include a red filter part, a green filter part, a blue filter part, a white filter part (e.g., a white light filter), and/or the like. However, the embodiment of the inventive concept is not limited thereto. The filter parts for allowing light in different wavelength regions to transmit therethrough, which are provided in the color filter layer CFL, may have various suitable arrangement sequences.

Although the two adjacent filter parts CF1 and CF2 are shown to partially overlap each other in the direction of the third directional axis DR3, which is a thickness direction, in FIG. 2, the embodiment of the inventive concept is not limited thereto. For example, the two adjacent filter parts CF1 and CF2 may be arranged to be spaced apart from each other. In this case, the light shielding part BM may be disposed between the spaced filter parts CF1 and CF2, or have at least a portion overlapping an edge of each of the spaced apart filter parts.

Referring to FIG. 2, the second substrate SUB2 may include a second polarizing layer POL2 disposed on the second base substrate BS2. Although the second polarizing layer POL2 is disposed on the second base substrate BS2 in FIG. 2, the embodiment of the inventive concept is not limited thereto. For example, the second polarizing layer POL2 may be disposed between the liquid crystal layer LCL and the second base substrate BS2.

The second polarizing layer POL2 may include a polarizer and at least one protective layer protecting the polarizer. The second polarizing layer POL2 may include a low reflection surface treated layer. That is, the second polarizing layer POL2 may be a low reflection polarizer including a low reflection surface treated layer. The second polarizing layer POL2, which is the low reflection polarizing layer, may reduce light reflected by the metal material of the circuit layer CL. The low reflection surface treated layer may be provided on a top surface of the second polarizing layer POL2.

In an embodiment of FIG. 2, the second polarizing layer POL2 provided in (e.g., on) the second substrate SUB2 may be a coating-type (e.g., coatable) polarizing layer and/or a polarizing layer formed through deposition. In one embodiment, unlike the above description, the second polarizing layer POL2 may be a film-type (e.g., a film) polarizing member that is separately manufactured and provided on the second base substrate BS2.

In an embodiment, the second substrate SUB2 may include both the circuit layer CL and the color filter layer CFL. That is, the liquid crystal display panel DP according to an embodiment may have a color filter on array (COA) structure in which the circuit layer CL and the color filter layer CFL are provided on one substrate.

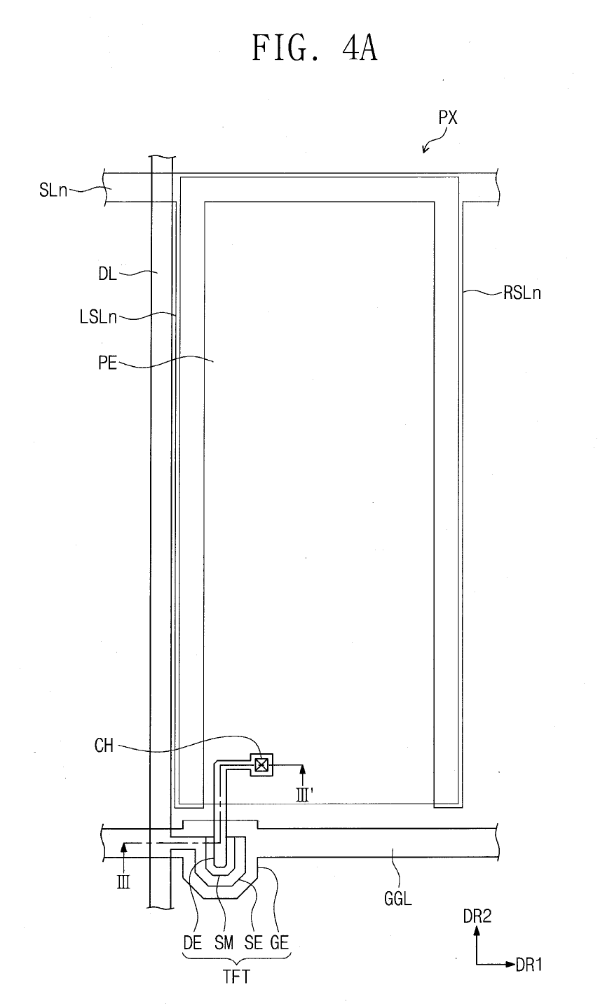

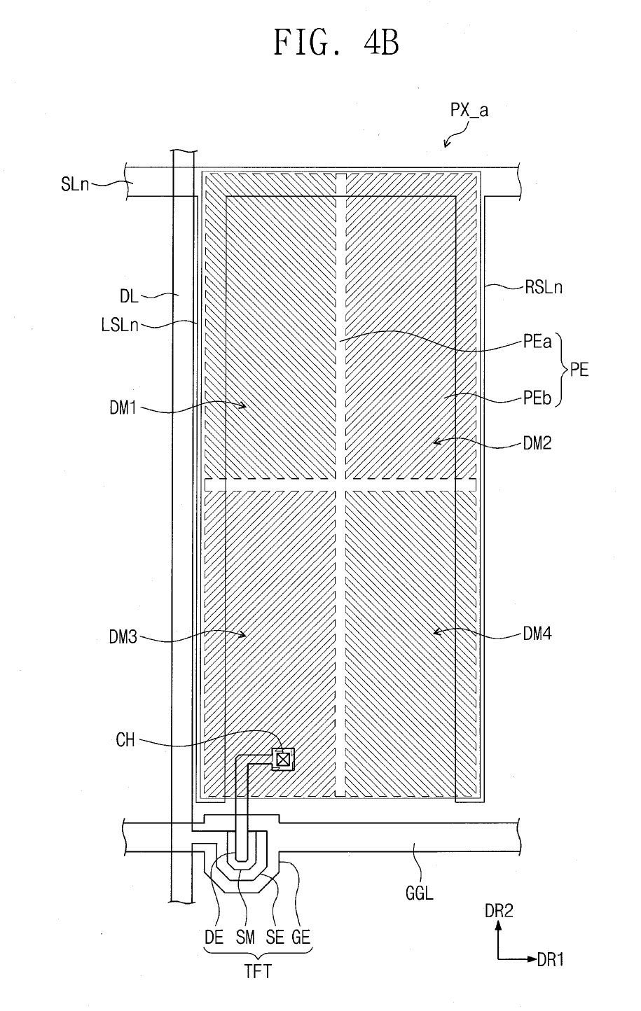

FIGS. 4A and 4B are a schematic plan views illustrating one of the pixels provided in the display device according to an embodiment. FIG. 5 is a cross-sectional view taken along the line III-III′ of FIG. 4A.

Although one pixel PX and PX-a is exemplarily illustrated in FIGS. 4A and 4B respectively, each of the rest of the pixels may have a structure similar to that of pixel PX and PX-a in FIGS. 4A and 4B respectively. Although the pixel PX and PX-a connected to one of the gate lines GGL and one of the data lines DL is illustrated for convenience of description in FIGS. 4A and 4B, the embodiment of the inventive concept is not limited thereto. For example, a plurality of pixels may be connected to one gate line and one data line, or one pixel may be connected to a plurality of gate lines and a plurality of data lines.

Referring to the illustrations of FIGS. 4A, 4B, and 5, the gate line GGL extends in the direction of the first directional axis DR1. The gate line GGL may be disposed on the second base substrate BS2. The data line DL may extend in the direction of the second directional axis DR2, which crosses the gate line GGL.

Each of the pixels PX and PX-a includes a thin film transistor TFT, a pixel electrode PE connected to the thin film transistor TFT, and a storage electrode part. The thin film transistor TFT may include a gate electrode GE, a semiconductor pattern SM, a first electrode SE (or a source electrode), and a second electrode DE (or a drain electrode). The storage electrode part may include (e.g., further include) a storage line SLn extending in the direction of the first directional axis DR1 and first and second branch electrodes LSLn and RSLn, which are branched from the storage line SLn to extend in the direction of the second directional axis DR2.

The gate electrode GE may protrude from the gate line GGL or be provided on a partial area of the gate line GGL. In an embodiment, the gate electrode may be disposed on a bottom surface BS2-B of the second base substrate BS2.

The gate electrode GE may be made of metal. The gate electrode GE may be made of one of nickel, chrome, molybdenum, aluminum, titanium, copper, tungsten, and/or an alloy thereof. The gate electrode GE may include (e.g., be constituted by) a single layer or multi-layers utilizing metals. For example, the gate electrode GE may include triple layers, in which molybdenum, aluminum, and molybdenum are sequentially stacked with each other; or double layers, in which titanium and copper are sequentially stacked with each other. In one embodiment, the gate electrode GE may be a single layer made of an alloy of titanium and copper.

The semiconductor pattern SM is disposed on a gate insulation layer GI. The semiconductor pattern SM is disposed on the gate electrode GE with the gate insulation layer GI therebetween. The semiconductor pattern SM has an area overlapping the gate electrode GE. The semiconductor pattern SM includes an active pattern disposed on the gate insulation layer GI and an ohmic contact layer disposed on the active pattern. The active pattern may include (e.g., be constituted by) an amorphous silicon thin film, and the ohmic contact layer may include (e.g., be constituted by) an n+ amorphous silicon thin film. The ohmic contact layer may allow the active pattern to have ohmic-contact between the first electrode SE and the second electrode DE.

The first electrode SE is branched from the data lines DL. The first electrode SE is disposed on the ohmic contact layer to partially overlap the gate electrode GE. The data line DL may be disposed on an area, on which the semiconductor pattern SM of the gate insulation layer GL is not disposed.

The second electrode DE is spaced apart from the first electrode SE with the semiconductor pattern SM therebetween. The second electrode DE is disposed on the ohmic contact layer to partially overlap the gate electrode GE.

Each of the first electrode SE and the second electrode DE may be made of (e.g., one of) nickel, chrome, molybdenum, aluminum, titanium, copper, tungsten, and/or an alloy thereof. Each of the first electrode SE and the second electrode DE may have a single layer or multi-layers utilizing metals. For example, each of the first electrode SE and the second electrode DE may have double layers, in which titanium and copper are sequentially stacked with each other. In one embodiment, each of the first electrode SE and the second electrode DE may have a single layer, which is made of an alloy of titanium and copper.

Accordingly, a top surface of the active pattern between the first electrode SE and the second electrode DE is exposed, and a channel part forming a conductive channel is defined between the first electrode SE and the second electrode DE according to whether a voltage is applied to the gate electrode GE. The first electrode SE and the second electrode DE partially overlap the semiconductor pattern SM except for the channel part, which is defined between the first electrode SE and the second electrode DE, and is spaced apart therefrom.

An insulation layer PS may be disposed to cover the first electrode SE, the second electrode DE, the channel part, and the gate insulation layer GI and to expose a portion of the second electrode DE. The second electrode DE exposed from the insulation layer PS may be connected to the pixel electrode PE. The insulation layer PS may include, e.g., silicon nitride and/or silicon oxide.

The pixel electrode PE partially overlaps the storage line SLn, the first branch electrode LSLn, and the second branch electrode RSLn to form a storage capacitor.

In comparison with FIG. 4A, FIG. 4B is different in that the pixel electrode PE is divided into a plurality of domains DM1, DM2, DM3, and DM4. In FIG. 4B, the pixel electrode PE includes a stem part PEa and a plurality of branch parts PEb radially protruding and extending from the stem part PEa. The stem part PEa or a portion of the branch parts PEb are connected to the second electrode DE through a contact hole CH.

The stem part PEa may have various suitable shapes. For example, the stem part PEa may have a cross shape in an embodiment of the inventive concept. The branch parts PEb are spaced not to meet each other, and extend in a direction parallel to each other within an area divided by the stem part PEa. The branch parts PEb, which are adjacent to each other, are spaced apart from each other by a micrometer unit (e.g., spaced apart from each other in the scale of a micrometer), which corresponds to a unit (e.g., a length scale) for aligning liquid crystal molecules of the liquid crystal layer LCL at a specific azimuth.

Each of the pixels PX-a may be divided into the plurality of domains DM1, DM2, DM3, and DM4 by the stem part PEa. The branch parts PEb may correspond to the domains DM1, DM2, DM3, and DM4, respectively, to extend in directions different from each other for each of the domains DM1, DM2, DM3, and DM4. Although each of the pixels PX includes four domains in an embodiment of the inventive concept, the embodiment of the inventive concept is not limited thereto. For example, each of the pixels PX-a may include various suitable numbers of domains such as two, six, or eight domains. Also, the embodiment of the inventive concept is not limited to the divided shape of the domains in FIG. 4B.

The circuit layer CL may include the thin film transistor TFT including the gate electrode GE, the semiconductor pattern SM, the first electrode SE, and the second electrode DE. In one embodiment, the circuit layer CL may include the thin film transistor TFT, the gate insulation layer GI, and the insulation layer PS.

Referring to FIG. 5, the color filter layer CFL may be disposed on the insulation layer PS. That is, the color filter layer CFL may be disposed between the circuit layer CL and the liquid crystal layer LCL. Although the color filter layer CFL overlaps only a portion of the thin film transistor TFT in FIG. 5, the embodiment of the inventive concept is not limited thereto. For example, the color filter layer CFL may cover the entire thin film transistor TFT.

An organic layer OC may be further disposed on the color filter layer CFL. The organic layer OC may be disposed between the liquid crystal layer LCL and the color filter layer CFL to function as a planarization film.

The second substrate SUB2 includes the pixel electrode PE. The pixel electrode PE may be connected to the second electrode DE through the contact hole CH defined by passing through the organic layer OC and the color filter layer CFL. The pixel electrode PE may be disposed below the organic layer OC to face the common electrode CE with the liquid crystal layer LCL therebetween.

The pixel electrode PE is made of a transparent conductive oxide. The transparent conductive oxide may include indium tin oxide (ITO), indium zinc oxide (IZO), and/or indium tin zinc oxide (ITZO).

Referring to FIG. 5, the liquid crystal display panel DP according to an embodiment may further include a column spacer CS. The column spacer CS may be disposed below the second substrate SUB2 while overlapping the thin film transistor TFT. The column spacer CS may protrude from the second substrate SUB2 toward the liquid crystal layer LCL while overlapping the thin film transistor TFT. The column space CS may serve as a support that maintains a cell gap CG of the liquid crystal layer LCL. Although a thickness t of the column spacer CS is shown to be less than the cell cap CG of the liquid crystal layer LCL in FIG. 5, the embodiment of the inventive concept is not limited thereto. For example, the thickness t of the column spacer CS may be the same as the cell gap CG of the liquid crystal layer LCL.

In one embodiment, the column spacer CS may be integrated with the light shielding part BM (refer to FIG. 2). For example, the light shielding part BM (refer to FIG. 2) may overlap the thin film transistor TFT, and the column spacer CS may be further disposed below the light shielding part BM (refer to FIG. 2).

The column spacer CS may contain a polymer resin and a pigment and/or a dye, which is dispersed in the polymer resin. For example, the column spacer CS may contain a black pigment and/or dye. The column spacer CS may block light provided to the thin film transistor TFT to protect the thin film transistor TFT.

As the color conversion layer CCM including the quantum dot is provided on the first base substrate so that the color conversion layer CCM is disposed in the liquid crystal display panel, the liquid crystal display panel according to an embodiment may reduce or prevent the color conversion layer CCM from being exposed to the external environment during a process of manufacturing the liquid crystal display device. Accordingly, the embodiment may provide the liquid crystal display panel with excellent color reproduction property and improved reliability of the color conversion layer CCM by internalization of (e.g., including) the color conversion layer CCM inside the liquid crystal display panel.

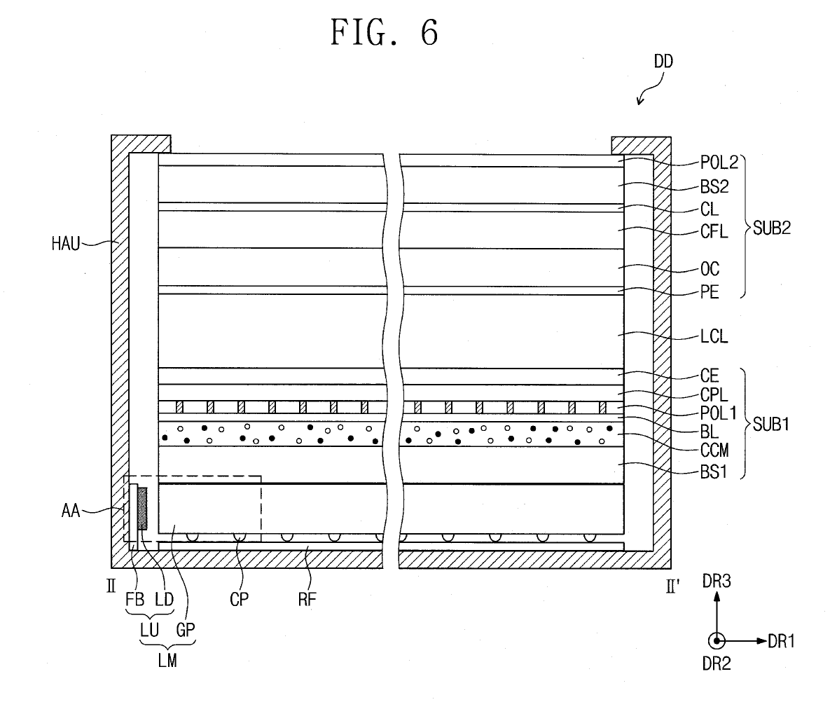

Hereinafter, the liquid crystal display device according to an embodiment will be described with reference to the drawings. FIG. 6 is a cross-sectional view illustrating the liquid crystal display device according to an embodiment. Here, the liquid crystal display panel DP provided in the liquid crystal display device DD according to an embodiment of FIG. 6 may correspond to the above-described liquid crystal display panel according to an embodiment, and the above description for the liquid crystal display panel according to the embodiments of FIGS. 1 to 5 may be also applied to the liquid crystal display panel DP of FIG. 6. The cross-sectional view of the liquid crystal display device DD according to the embodiment of FIG. 6 may be a view taken along the line II-II′ of FIG. 1.

The liquid crystal display device DD according to an embodiment may include a light source member LM and a liquid crystal display panel DP. Also, the liquid crystal display device DD according to an embodiment may further include a housing HAU accommodating the light source member LM and the liquid crystal display panel DP.

The liquid crystal display panel DP includes a first substrate SUB1 and a second substrate SUB2, which face each other, with a liquid crystal layer LCL disposed therebetween. The first substrate SUB1 may include a first base substrate BS1, a color conversion layer CCM, a first polarizing layer POL1, and a common electrode CE. Also, the liquid crystal display device DD according to an embodiment of FIG. 6 may include a second base substrate BS2, a second polarizing layer POL2, a circuit layer CL, a color filter layer CFL, and a pixel electrode PE. The above description regarding the liquid crystal display panel according to an embodiment may be applied to the constitution of each of the first substrate SUB1 and the second substrate SUB2 in the same manner.

Referring to FIG. 6, in an embodiment, the color conversion layer CCM may be disposed inside the liquid crystal display panel DP. The liquid crystal display panel DP may include a barrier layer BL, and the barrier layer BL may be disposed to cover the color conversion layer CCM. For example, the barrier layer BL may serve as an encapsulation layer sealing the color conversion layer CCM.

A light source member LM may provide light to the liquid crystal display panel DP. The light source member LM may be disposed below the liquid crystal display panel DP. The light source member LM may include a light source LU and a guide panel GP.

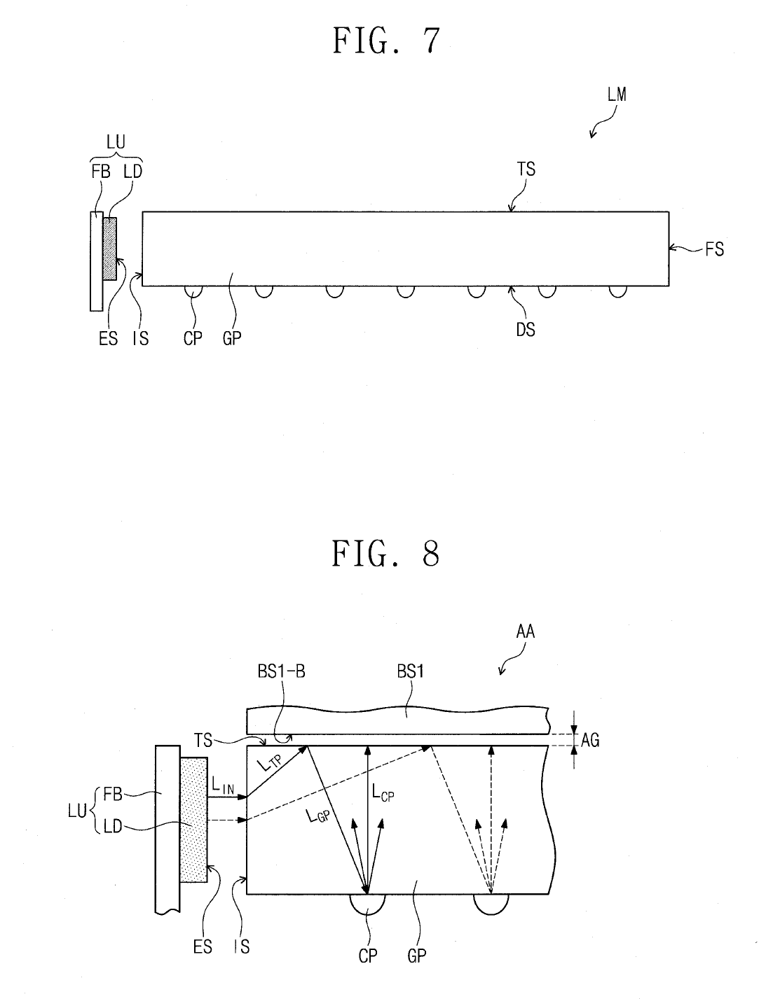

FIG. 7 is a view illustrating the light source member LM in more detail. Referring to FIGS. 6 and 7, the light source LU may include a circuit board FB and a light emitting element LD disposed on the circuit board FB.

The circuit board FB may provide power to the light emitting element LD mounted thereto. For example, the circuit board FB may provide a dimming signal and a driving voltage to the light emitting element LD mounted thereto. The circuit board FB may include at least one insulation layer and at least one circuit layer. For example, the circuit board FB may be a metal core printed circuit board (MCPCB).

Also, a plurality of light emitting elements LD may be disposed on the circuit board FB. The light emitting elements LD, which generates light in response to a voltage provided from the circuit board FB, may have a structure in which an n-type semiconductor layer, an active layer, and a p-type semiconductor layer are sequentially laminated, and emit light when a driving voltage is applied while an electron and a hole move to be re-coupled (e.g., recombined) to each other.

The plurality of light emitting elements LD may emit light in the same wavelength region. In one embodiment, the light source member LM may include a plurality of light emitting elements LD emitting light in different wavelength regions. In an embodiment, the light emitting elements LD may emit blue light.

The light emitting element LD may have a light emitting surface ES facing one side surface of the guide panel GP. The one side surface of the guide panel GP, which faces the light emitting surface ES of the light emitting element LD, may correspond to a light incident surface IS. The guide panel GP may include an opposite surface FS, which faces the light incident surface IS, and light incident through the light incident surface IS may be guided to the opposite surface FS. The light provided to the guide panel GP may be outputted through an emission surface TS and provided to the liquid crystal display panel DP. The emission surface TS may correspond to a top surface of the guide panel GP.

The guide panel GP may be a glass substrate. However, the embodiment of the inventive concept is not limited thereto. For example, the guide panel GP may be a transparent resin substrate. The guide panel GP may contain, e.g., an acryl-based resin.

A plurality of emission patterns CP may be disposed on a bottom surface DS of the guide panel GP. The emission patterns CP may be made of a material having a reflective index different from the guide panel GP.

The emission patterns CP may change a direction of light so as to transmit light, which is discharged from the light source member and incident on one side surface of the guide panel GP, to another side surface of the guide panel GP or transmit light, which is incident on the bottom surface DS of the guide panel GP, to the emission surface TS, which is a top surface of the guide panel GP. The emission patterns CP may change a path of light provided to the bottom surface DS of the guide panel GP and allow light to be outputted toward the liquid crystal display panel DP.

Each of the emission patterns CP may have a lens shape protruding from the bottom surface DS of the guide panel GP. Each of the emission patterns CP may be disposed on the bottom surface DS of the guide panel GP and have a semi-spherical shape. The emission patterns CP may be integrated from the guide panel GP while protruding from the bottom surface DS of the guide panel GP.

FIG. 8 is a cross-sectional view illustrating an area AA of FIG. 6 in more detail. Referring to FIGS. 6 to 8, the liquid crystal display panel DP may be spaced apart from the light source member LM. That is, the liquid crystal display panel DP may be disposed on the light source member LM, and the liquid crystal display panel DP and the guide panel GP of the light source member LM may not closely contact each other. In the liquid crystal display device DD according to an embodiment, an air gap AG may be defined (e.g., be present) between the guide panel GP and the liquid crystal display panel DP. In one embodiment, the air gap AG may be defined between the guide panel GP and the first base substrate BS1, which is a lower substrate of the liquid crystal display panel DP. That is, a bottom surface BS1-B of the first base substrate BS1 of the liquid crystal display panel DP and the emission surface TS, which is the top surface of the guide panel GP, may not (e.g., not entirely) contact each other, and thus the air gap AG may exist between the bottom surface BS1-B of the first base substrate BS1 and the emission surface TS of the guide panel GP.

FIG. 8 is a schematic view illustrating a light traveling path in the light source member. Referring to FIG. 8, light L_{IN}, which is emitted from the light emitting element LD of the light source LU, is incident on the light incident surface IS of the guide panel GP, and light L_{TP}, which is incident into the guide panel GP and provided to the emission surface TS that is the top surface of the guide panel GP, is refracted by an interface of the emission surface TS and transmitted in the guide panel GP. The light L_{TP} provided to the top surface of the guide panel GP may be refracted by the interface of the emission surface TS and provided to the emission pattern CP as a refracted light L_{GP}. The light provided to the emission pattern CP may have a light path that is changed from the emission pattern CP to the emission surface TS. That is, the light L_{GP} provided to the emission pattern CP may have a light path, which is changed due to a difference between refractive indexes of the emission pattern CP and the guide panel GP and be emitted as emission light L_{CP} toward the first base substrate BS1.

That is, in the light source member LM according to an embodiment, the lower refractive index layer is not provided on the guide panel GP, and the light L_{TP} provided to the top surface of the guide panel GP by utilizing the air gap AG defined between the guide panel GP and the liquid crystal display panel DP is refracted by the interface of the emission surface TS and guided in the guide panel GP, thereby being transmitted to the opposite surface FS (refer to FIG. 7). In one embodiment, the guide panel GP may serve as a light guide plate by utilizing the air gap AG defined between the guide panel GP and the liquid crystal display panel DP.

Also, the liquid crystal display device DD according to an embodiment of FIG. 6 may further include a reflective member RF. The reflective member RF may be disposed below the guide panel GP. The reflective member RF may face the emission pattern CP. The reflective member RF may include a reflective film and/or a reflective coating layer. The reflective member RF reflects light emitted to the bottom surface of the guide panel GP and allows the reflected light to be re-incident into the guide panel GP of the light source member LM.

Also, the light source member LM according to an embodiment may include the emission patterns CP disposed on the bottom surface DS of the guide panel GP to emit light transmitted in the guide panel GP toward the emission surface TS.

The light emitted from the light source LU and guided in the guide panel GP is incident onto the liquid crystal display panel DP. For example, the light emitted from the light source LU may pass through the light conversion layer CCM and be provided as white light to the liquid crystal layer LCL. That is, blue light provided from the light source LU is converted into green light and red light by the first and second quantum dots QD1 and QD2 of the color conversion layer CCM, respectively, and the light transmitted through the light conversion layer CCM is finally provided as white light, in which the blue light, the green light, and the red light are mixed, to the liquid crystal layer LCL.

In an embodiment, the liquid crystal display device including the color conversion layer, which is disposed in the liquid crystal display panel and contains the quantum dot, to maintain a high color reproduction property, and reduction or minimization of damage on the color conversion layer may be realized. In one embodiment, in the liquid crystal display device according to an embodiment, as the color conversion layer is removed from the light source member, and the color conversion layer is disposed inside the liquid crystal display panel, the low refractive index layer, which is disposed below the color conversion layer for the light guide function when the color conversion layer is provided in the light source member, may be removed (e.g., not included). Thus, the liquid crystal display device according to an embodiment may have satisfactory reliability by improving a reliability limitation, which is generated during manufacturing and assembling of the low refractive index layer.

In an embodiment, the liquid crystal display panel, which maintains excellent optical characteristics and has improved reliability of the color conversion layer by disposing the color conversion layer inside the liquid crystal display panel, may be provided.

In an embodiment, the liquid crystal display panel, which excludes the low refractive index layer from the light source member and has improved reliability of the color conversion layer by disposing the color conversion layer inside the liquid crystal display panel, may be provided.

Although the exemplary embodiments of the present invention have been described, it is understood that the present invention should not be limited to these exemplary embodiments but various suitable changes and modifications can be made by one ordinary skilled in the art within the spirit and scope of the present invention as hereinafter claimed.

Hence, the real protective scope of the inventive concept shall be determined by the technical scope of the accompanying claims, and equivalents thereof.

What is claimed is:

1. A liquid crystal display panel comprising:
a first substrate;
a second substrate facing the first substrate; and
a liquid crystal layer between the first substrate and the second substrate,
wherein the first substrate comprises:
a first base substrate;
a color conversion layer on the first base substrate and comprising a quantum dot; and
a first polarizing layer on the color conversion layer.

2. The liquid crystal display panel of claim 1, wherein the second substrate comprises:
a second base substrate;
a second polarizing layer on the liquid crystal layer;
a circuit layer on a surface of the second base substrate, the surface facing the liquid crystal layer; and
a color filter layer between the liquid crystal layer and the circuit layer.

3. The liquid crystal display panel of claim 1, wherein the color conversion layer is directly on the first base substrate.

4. The liquid crystal display panel of claim 1, further comprising a barrier layer on the color conversion layer.

5. The liquid crystal display panel of claim 1, wherein the first polarizing layer is a wire grid polarizer.

6. The liquid crystal display panel of claim 5, further comprising a capping layer on the first polarizing layer.

7. The liquid crystal display panel of claim 2, wherein the second polarizing layer is a low reflection polarizer.

8. The liquid crystal display panel of claim 2, wherein the circuit layer comprises a thin film transistor, the thin film transistor comprising a gate electrode, a first electrode, a second electrode, and a semiconductor pattern, and
the liquid crystal display panel further comprises a column spacer overlapping the thin film transistor and protruding from the second substrate toward the liquid crystal layer.

9. The liquid crystal display panel of claim 8, wherein the column spacer comprises a polymer resin and/or a pigment or a dye dispersed in the polymer resin.

10. A liquid crystal display device comprising:
a light source member; and
a liquid crystal display panel on the light source member,
wherein the liquid crystal display panel comprises:
a first substrate;
a second substrate facing the first substrate; and
a liquid crystal layer between the first substrate and the second substrate,
wherein the first substrate comprises:
a first base substrate;
a color conversion layer on the first base substrate and comprising a quantum dot; and
a first polarizing layer on the color conversion layer.

11. The liquid crystal display device of claim 10, wherein the light source member comprises:
a light source comprising a circuit board and a light emitting element on the circuit board; and
a guide panel configured to guide light from the light source to the liquid crystal display panel.

12. The liquid crystal display device of claim 11, wherein the guide panel comprises a plurality of emission patterns on a bottom surface thereof.

13. The liquid crystal display device of claim 12, wherein each of the plurality of emission patterns has a lens shape protruding from the bottom surface of the guide panel.

14. The liquid crystal display device of claim 11, wherein the light emitting element is to emit blue light, and
the quantum dot comprises a first quantum dot to be excited by the blue light to emit green light and a second quantum dot to be excited by the blue light to emit red light.

15. The liquid crystal display device of claim 10, wherein the second substrate comprises:
a second base substrate:
a second polarizing layer on the liquid crystal layer;
a circuit layer on a surface of the second base substrate, the surface facing the liquid crystal layer; and
a color filter layer between the liquid crystal layer and the circuit layer.

16. The liquid crystal display device of claim 11, wherein the light source is on at least one side surface of the guide panel.

17. The liquid crystal display device of claim 11, further comprising an air gap between the liquid crystal display panel and the guide panel.

18. A liquid crystal display device comprising:
a light source member; and
a liquid crystal display panel on the light source member,
wherein the liquid crystal display panel comprises:
a first substrate;
a second substrate facing the first substrate; and
a liquid crystal layer between the first substrate and the second substrate,
wherein the light source member comprises:
a light source configured to emit blue light; and
a guide panel having one side surface facing an emission surface of the light source,
the first substrate comprises:
a first base substrate;
a color conversion layer directly on the first base substrate and comprising a first quantum dot to be excited by the blue light to emit green light and a second quantum dot to be excited by the blue light to emit red light; and
a first polarizing layer on the color conversion layer, and
the second substrate comprises:
a color filter layer on the liquid crystal layer;
a circuit layer on the color filter layer;
a second base substrate on the circuit layer; and
a second polarizing layer on the second base substrate.

19. The liquid crystal display device of claim 18, wherein the liquid crystal display panel is on the light source member and is spaced apart therefrom.

20. The liquid crystal display device of claim 18, wherein the guide panel comprises a plurality of emission patterns protruding from a bottom surface thereof.
